(19) United States
(12) Patent Application Publication
(10) Pub. No.: US 2005/0044400 A1
(43) Pub. Date: Feb. 24, 2005

(54) OPTICAL DISK DRIVE CAPABLE OF DETECTING VIRUS AND CORRESPONDING METHOD

(76) Inventors: Li Li, Han Chuan City (CN); Jing-Tsung Lee, Chia-Yi Hsien (TW)

Correspondence Address: (NAIPC) NORTH AMERICA INTERNATIONAL PATENT OFFICE, P.O. BOX 506, MERRIFIELD, VA, 22116, US

(21) Appl. No.: 10/710,502

(22) Filed: Jul. 15, 2004

(30) Foreign Application Priority Data
Jul. 17, 2003 (TW) 092119568

(51) Int. Cl. G06F 11/30

(52) U.S. Cl. 713/200

(57) ABSTRACT

An optical disk drive for reading data of an optical disk includes a first memory for storing a virus code, a second memory for storing data temporarily, a controller for storing the data of the optical disk temporarily into the first memory and comparing the data of the optical disk stored in the first memory and the virus code stored in the optical disk drive to scan the data of the optical disk for viruses.

### BACKGROUND OF INVENTION

1. Field of the Invention

The present invention relates to an optical disk drive and more specifically, to an optical disk drive capable of detecting viruses.

2. Description of the Prior Art

A computer virus is a malicious program capable to destroy data in a computer. Generally, computer viruses can be divided into virus, worm and Trojan. Viruses are designed specifically to spread or attach themselves to other programs or files. For instance, some viruses reproduce themselves, and some others destroy data in the computer or even the whole computer system. A worm is also a kind of virus, but the difference is that a worm is not attached to other files but repeatedly reproduces itself and spreads to other computers through a network like a real worm would dig through soil. Trojans externally look like a benign application such as a screensaver or a game, but they destroy or steal data and passwords in a computer. Trojans do not reproduce themselves nor spread to other computers. Computer viruses can spread by disk, the Internet and e-mail. They can be downloaded and sometimes, they are attached to applications in purpose. Typically, a computer virus does not spread on its own. It needs to be executed first before it starts to operate. For instance, a virus operates after booting a computer with a disk with a boot infection virus inside, or after opening a document with a macro virus, or after opening an e-mail with a mixture virus. When a computer virus is attached to a file, the file can be executed normally, but the size, date or properties may change. Moreover, the virus will try to grasp the authority of the operating system when executed and spread to other files. The virus generally reproduces its program code and attaches or covers it onto other files. When a file is infected by a virus, it is likely that it will become un-executable or even cause the computer to crash. Many computer viruses have an incubation period before they try to damage the computer system. For instance, some viruses operate on a fixed date or after the program is executed for a specific number of times. But even in the incubation period, the virus operates every time it is executed.

Although not all computer viruses destroy a computer system, they are surely a trouble. Thus it is very important to prevent computer viruses from invading a computer system. The rise of the Internet is a main reason for the spread of computer viruses. In addition to that, viruses spread with the help of portable storage media such as disks and optical disks. An infected optical disk may be used repeatedly, giving the virus an opportunity to spread. Especially in case of an unwritable CD-ROM, if a user burns viruses into a CD-ROM, it will become a main source for viruses. In order to prevent infection by viruses, one should not use applications, files and disks without clear references or one can install virus scan programs to prevent the spread of viruses.

### SUMMARY OF INVENTION

It is therefore an objective of the present invention to provide an optical disk drive capable of detecting viruses.

Briefly summarized, the present invention discloses a method for scanning data of an optical disk by an optical disk drive. The method includes reading the data of the optical disk, and comparing the data of the optical disk with a virus code stored in the optical disk drive to scan the data of the optical disk.

Also according to the present invention, an optical disk drive for reading data of an optical disk, the optical disk drive comprising: a first memory for storing a virus code; a second memory for storing data temporarily; and a controller for controlling the data of the optical disk to be temporarily stored into the second memory, and comparing the data of the optical disk stored in the second memory and the virus code stored in the first memory to scan the data of the optical disk for viruses.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a mobile phone according to the present invention.

FIG. 2 is a flowchart of a method for managing incoming calls on the mobile phone according to the present invention.

### DETAILED DESCRIPTION

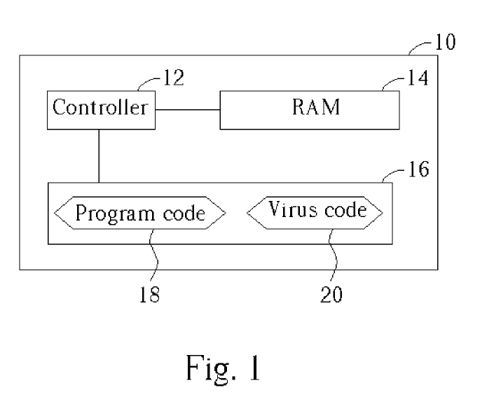

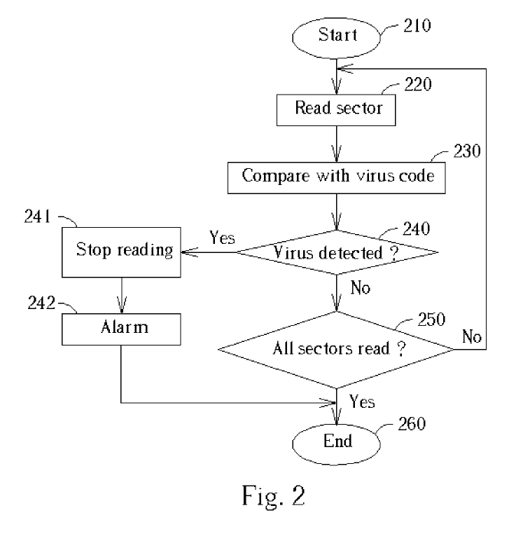

Please refer to FIG. 1 showing the structure of an optical disk drive 10 according to the present invention. The optical disk drive 10 includes a controller 12, a random access memory (RAM) 14 and a non-volatile memory 16. The controller 12 is for managing the reading and writing of the optical disk drive 10, the RAM 14 and the non-volatile memory 16 are electrically connected to the controller 12. RAM 14 is for storing temporarily data needed for reading and writing an optical disk. Typical non-volatile memory includes EEPROM and flash memory, which can keep the stored data after power is removed. The non-volatile memory 16 stores a program code 18 and a virus code 20. The controller 12 controls the optical disk drive 10 according to the program code 18, the virus code 20 records the features of computer viruses. Since new viruses come out constantly, the virus code 20 requires periodic update. The two non-volatile memories can update the virus code 20 by voltage. The optical disk is read by the optical disk drive 10 sector by sector, wherein each sector is 2352 bits in size. The optical disk drive 10 reads the sectors one by one and temporarily stores the data into the RAM 14. The size of the RAM 14 is accorded to the type of the optical disk drive 10. In order to prevent the optical disk drive 10 from copying a virus to a computer system, every time when the optical disk drive 10 writes a sector and stores the data into the RAM 14, the controller 12 compares the data stored in the RAM 14 with the virus code 20 stored in the non-volatile memory 16 to detect if a virus exists. More specifically, the controller 12 controls the data of the optical disk to be temporarily stored into the RAM 14, and compares the data of the optical disk stored in the RAM 14 and the virus code 20 stored in the non-volatile memory 16 to scan the data of the optical disk for viruses. The optical disk drive 10 looks for viruses every time when it reads an optical disk. The optical disk drive 10 can also be used as a virus scanner. Insert an optical disk and activate virus scanning, the optical disk drive 10 will scan for viruses on the optical disk. When a virus is detected, the reading is stopped and an alarm such as buzzing or light blink goes off or the withdrawing of the disk is implemented. Please refer to FIG. 2: FIG. 2 shows a flowchart of the method of virus scanning by the optical disk drive 10 according to the present invention. The optical disk drive 10 detects viruses as follows:

Step 210: Activate virus scanning of the optical disk drive 10;

Step 220: Read a sector and store the data into the RAM 14;

Step 230: Compare the data stored in the RAM 14 and the virus code 20 stored in the non-volatile memory 16;

Step 240: Is any virus detected? If the data stored in the RAM 14 has the same feature to that of the virus code 20, the read sector has a virus proceed to Step 241. If no proceed to Step 250;

Step 241: A virus is detected, the optical disk drive 10 stops reading;

Step 242: Generate an alarm such as a buzz, a blinking light or implements withdraw of the optical disk;

Step 250: Are all of the sectors readable? If yes, proceed to Step 260, if no, proceed to Step 220;

Step 260: Finish virus detection. The optical disk drive 10 can read the optical disk normally.

According to the steps mentioned above, for instance, a “marijuana” virus uses 1F 58EA 1A AF 00 F0 9C code, the code is recorded in the virus code 20. When the optical disk drive 10 finds the data stored in the RAM 14 in Step 230, the virus is confirmed. The optical disk drive 10 stops reading the optical disk and notifies the user by a blinking light and withdraws the optical disk. As described above, the optical disk drive 10 can scan a virus of an optical disk. If a virus is detected, the optical disk drive 10 stops reading the optical disk to prevent the virus from spreading. The data of viruses are stored in the non-volatile memory 16, the optical disk drive 10 includes the controller 12, RAM 14 and non-volatile memory 16. The non-volatile memory 16 stores the program code 18 and the virus code 20, the controller 12 reads the optical disk according to the program code 18 and stores the data of a sector into the RAM 14, and then compares the data stored in the RAM 14 with the virus code 20 to detect a virus. Moreover, the non-volatile memory 16 can be updated to prevent a virus effectively. In addition, the optical disk drive 10 can operate independently without the computer system as a simple virus scanner or applied in an independent burner or a disk copier to prevent the reproduction of infected disks.

In contrast to the prior art, the optical disk drive according to the present invention provides a virus scanning method. A virus code is stored in its non-volatile memory, so that every time when the optical disk drive reads an optical disk, the virus scan is executed to prevent viruses from spreading. Because optical disks are widely used, it is highly possible that they may be infected by a virus.

A conventional virus scan program is often installed in a computer system. However, when a virus is detected, it has already infected the computer system Nonetheless, in case a burner is independent from a computer system, the virus scan program cannot operate. Therefore, the optical disk drive, according to the present invention, can prevent viruses spreading through optical disks.

Those skilled in the art will readily observe that numerous modifications and alterations of the device may be made while retaining the teachings of the invention. Accordingly, the above disclosure should be construed as limited only by the metes and bounds of the appended claims.

1. A method for scanning data of an optical disk for viruses by an optical disk drive, the method comprising:
reading the data of the optical disk; and
comparing the data of the optical disk with a virus code stored in the optical disk drive to scan the data of the optical disk for viruses.

2. The method of claim 1, further comprising storing the virus code into a first memory of the optical disk drive.

3. The method of claim 1 further comprising storing the data of the optical disk into a second memory of the optical disk drive.

4. The method of claim 1 wherein the data of the optical disk is stored in a sector.

5. The method of claim 1 further comprising generating an alarm when the data of the optical disk matches the virus code in the first memory.

6. The method of claim 1 further comprising stopping reading the data of the optical disk when the data of the optical disk matches the virus code in the first memory.

7. The method of claim 1 wherein the first memory is a non-volatile memory.

8. The method of claim 3 wherein the second memory is a random access memory (RAM).

9. An optical disk drive for reading data of an optical disk, the optical disk drive comprising:
a first memory for storing a virus code;
a second memory for storing data temporarily; and
a controller for controlling the data of the optical disk to be temporarily stored into the second memory, and comparing the data of the optical disk stored in the second memory and the virus code stored in the first memory to scan the data of the optical disk for viruses.

10. The optical disk drive of claim 9, wherein the first memory is a non-volatile memory.

11. The optical disk drive of claim 9, wherein the second memory is a random access memory (RAM).
